(19) United States
(12) Patent Application Publication
(10) Pub. No.: US 2021/0205779 A1
(43) Pub. Date: Jul. 8, 2021

(54) PROCESS FOR URANIUM REMOVAL FROM NEAR NEUTRAL AQUEOUS SOLUTIONS BY FRESHLY PREPARED FINE FERRIHYDRITE GENERATED DURING ULTRASONIC ASSISTED CORROSION OF MILD STEEL WOOL

(71) Applicant: Secretary, Department of Atomic Energy, Mumbai (IN)

(72) Inventors: J. G. SHAH, Mumbai (IN); S. A. KHOT, Mumbai (IN); A. ANANTHANARAYANAN, Mumbai (IN); K. AGARWAL, Mumbai (IN)

(21) Appl. No.: 16/733,388

(22) Filed: Jan. 3, 2020

(51) Int. Cl. B01J 20/06; G21F 9/12; C01G 49/06; B01J 20/30

(52) U.S. Cl. CPC B01J 20/06; B01J 20/3085; C01G 49/06; G21F 9/12

(57) ABSTRACT

A Process for uranium removal from near neutral aqueous solutions by freshly prepared fine ferrihydrite generated during ultrasonic assisted corrosion of mild steel wool is disclosed. The above process is a simple and scalable process which minimizes agglomeration and reduces likelihood of aging of the ferrihydrite.

### FIELD OF THE INVENTION

Embodiments described herein relate to a process for uranium removal from near neutral aqueous solutions by freshly prepared fine ferrihydrite generated during ultrasonic assisted corrosion of mild steel wool. More specifically, the present invention relate to a process for Uranium removal from near neutral aqueous solutions by freshly prepared fine ferrihydrite generated during ultrasonic assisted corrosion of mild steel wool wherein the same is transferred to a process tank before agglomeration, thereby allowing highly efficient U sorption.

### BACKGROUND OF THE INVENTION

Uranium, entering groundwater due to anthropogenic and natural factors has both toxicological and radiological impact on human health. The uranous ion produces a toxic effect on the living cells as it interferes with the metabolism of carbohydrates by the inhibition of enzyme systems. Additionally, it accumulates in tissues such as the kidneys, the liver and the bones, presenting a continuously increasing radiological/heavy metal hazard. The toxicity of uranium is a function of the route of exposure, particle solubility, contact time, and route of elimination In view of its toxicity and complex environmental chemistry, the world health organization (WHO) recommends a permissible limit of U in drinking water of 30 μgl⁻¹.

The most efficient method for uranium removal is largely decided by the speciation of uranium in the aqueous stream. uranium exists in aqueous solution under toxic conditions in U(VI) charge state, as the linear dioxo UO₂²⁺ cation, which favours co-ordination from hard ligands in the plane orthogonal to the QUO axis. Thus, the specifications of the uranyl ion is very pH-dependent, partly due to hydrolysis, but also due to the formation of carbonate species in systems open to atmospheric CO₂ or where carbonate minerals are present. For micromolar uranyl concentrations, the UO₂²⁺ cation tends to predominate at pH values below about 5. In the pH range 5-7, other cationic species (such as UO₂OH⁺ and (UO₂)₃(OH)₅⁺) as well as neutral and anionic species (such as UO₂C_{O3} and (UO₂)₂CO₃(OH)₃⁻) are important. At pH values much above 8, only anionic species (such as UO₂(CO₃)₂²⁻ and UO₂(CO₃)₃⁴⁻) tend to be significant. Therefore, in the pH range typical for potable water both anionic and cationic uranium species are significant and any sorbent must have a capability to remove both.

Various materials have been described in the literature for the removal of uranium from groundwater including natural materials such as coir pitch, various biological methods such as algae or even water hyacinths, surface sorption on minerals such as clinoptilite, nano-crystalline titania, modified cellulosic membranes functionalized by activated carbon or modified zeolites. However, these techniques are generally limited by the volume of water that can be handled and secondary waste generation.

Uranium removal by sorption on to iron corrosion products such as ferrihydrite, goethite etc. has been discussed in previous literatures. Indeed, it has been established that at near neutral pH, the surface of ferrihydrite contains both positive and negatively charged surface exchange >OH sites which allow efficient removal of both anionic and cationic uranium species. Since Uranium sorption is a surface driven process, high surface area of ferrihydrite increases its efficacy as a sorbent. However, the charged nature of the Ferrihydrite particles also leads to rapid agglomeration, reduction in surface area and a consequent reduction in uranium uptake. A similar situation results under aging of high surface area two line ferrihydrite into other iron oxy-hydroxides such as goethite. Ex-situ synthesis of ferrihydrite nano particles is highly involved, and requires storage of ferrihydrite under agitation in anoxic conditions, which limits scale-up.

Hence, there is a need to develop a process for uranium removal from aqueous solutions which overcomes the aforementioned drawbacks.

### OBJECT OF THE INVENTION

The main objective of the invention is to develop a simple and scalable process for the sequestration of uranium with minimal generation of secondary wastes by freshly generating ferrihydrite from corrosion of mild steel wool under ultrasonication, so as to remove the corrosion inhibiting, adherent surface oxide layer from the mild steel wool surface.

It is yet another objective of the invention to minimize passivation of the mild steel by cavitation action in an ultrasonic bath to freshly generate fine ferrihydrite corrosion product, which is then circulated to the process tank to minimize agglomeration, which along with reducing surface activity by aging can deleteriously impact uranium uptake efficiency. Typical ultrasonic power and frequency are 1-2 kW and 20 kHz respectively.

### SUMMARY OF THE INVENTION

According to an embodiment of the invention, a process for uranium removal from near neutral aqueous solutions by freshly prepared fine ferrihydrite generated during ultrasonic assisted corrosion of mild steel wool is disclosed wherein the uranium bearing aqueous solution is taken in a process tank and the mild steel wool is taken in a generation tank, which is placed in a ultrasonic bath, characterized by the following steps, (a) generating two line ferrihydrite by corrosion of mild steel wool in the ultrasonic bath by ultrasonic agitation; (b) transferring the two line ferrihydrite using a pump from the generation tank to the process tank; (c) mixing of the two line ferrihydrite in the process tank with the uranium bearing aqueous solution using air bubbling/air purging; (d) circulating the solution from the process tank to the generation tank using an overflow line; (e) repeating the steps (a) to (d) for 3 to 4 hours; (f) removing the solution of step (d) to another container; (g) settling of fine ferrihydrite corrosion product from the solution using alum applied as flocculent. The following process steps are performed typically in 100 litres tap water spiked with 500 ppb uranium (uranyl nitrate salt), at pH of 7.2 taken in the process tank. 5 mg of mild steel wool and the ultrasonic bathing was operated at a power of 1-2 kW and a frequency of 20 kHz.

Additional features and advantages are realized through the techniques of the present invention. Other embodiments and aspects of the invention are described in detail herein and are considered a part of the invention. For a better understanding of the invention with the advantages and the features, refer to the description and the drawings (if any).

### BRIEF DESCRIPTION OF DRAWINGS

This invention is illustrated in the accompanying drawings, throughout which like reference letters indicate corresponding parts in various figures. The embodiments herein will be better understood form the following description with reference to the drawings, in which:

FIG. 1 illustrates the basic flow process for removal of Uranium from neutral (pH 6-8) aqueous solution along with the major components.

FIG. 2 illustrates a working setup of the process for removal of Uranium from neutral (pH 6-8) aqueous solution along with the major components.

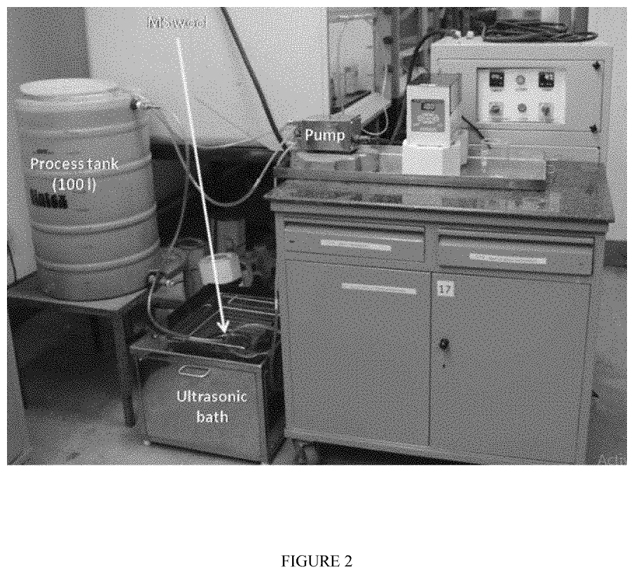

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

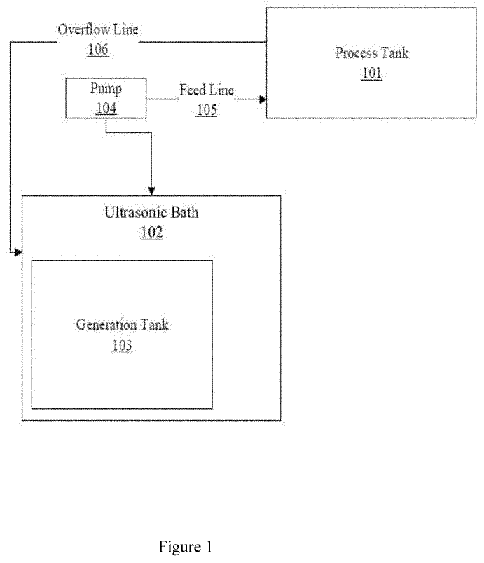

FIG. 1 illustrates the basic flow process for removal of Uranium from neutral (pH 6-8) aqueous solution along with the major components, to illustrate its overall working in accordance with an embodiment of the present disclosure.

According to an embodiment, the uranium bearing aqueous solution at pH range of 6-8 is taken to a process tank (101) as described in the flow chart. Mild steel wool is taken in a generation tank (103), which is placed in an ultrasonic bath (102). The typical ultrasonic frequency and power levels are 20 kHz and 1-2 kW respectively. The quantity of mild steel wool taken is 5 g for 100 litres of aqueous solution in the process tank (101). After the step of ultrasonication of the mild steel wool in the ultrasonic bath (102), two line ferrihydrite by corrosion of mild steel wool is generated. The two line ferrihydrite freshly generated under ultrasonication is transferred using a pump (104) from the generation tank (103) to the process tank (101) via a feed line (105). In an embodiment, the rate of transfer is optimized at 8-10 lph. This flow rate allows uranium removal in less than 3 h, while preventing agglomeration and ageing which in turn efficiently absorbs uranium from the aqueous solution in the process tank (101). Then the two line ferrihydrite in the process tank (101) is mixed with the uranium bearing aqueous solution using air bubbling/air purging. An overflow line (106) is used to circulate solution from the process tank (101), back to the generation tank (103) and the process continues.

While the foregoing describes various embodiments of the system, other and further embodiments of the system may be devised without departing from the basic scope thereof. The scope of the system is determined by the claims that follow. The system is not limited to the described embodiments, versions or examples, which are included to enable a person having ordinary skill in the art to make and use the system when combined with information and knowledge available to the person having ordinary skill in the art.

Hence, while some embodiments of the present disclosure have been illustrated and described, those are completely exemplary in nature. The disclosure is not limited to the embodiments as elaborated herein only and it would be apparent to those skilled in the art that numerous modifications besides those already described are possible without departing from the inventive concepts herein. All such modifications, changes, variations, substitutions, and equivalents are completely within the scope of the present disclosure. The inventive subject matter, therefore, is not to be restricted except in the spirit of the appended claims.

### MAIN ADVANTAGES OF THE INVENTION

Fine ferrihydrite particles are freshly generated by corrosion of mild steel wool in an ultrasonic bath, precluding any external chemical addition.

Ultrasonication and immediate transfer of the ferrihydrite ensures that the ferrihydrite particles are fine and do not agglomerate or age in the generation tank, allowing high surface activity, which is important to ensure efficient uranium sorption performance.

Since ferrihydrite is generated in an ultrasonic bath, passivation of the mild steel wool is prevented, as adherent oxide layer is efficiently dislodged.

The small volume of the generation tank, and the immediate transfer of freshly generated corrosion product ensures that there is no significant pH change in the treated aqueous solution due to the process.

Mild steel wool passivation is prevented, which allows complete use of the mild steel wool. As a result, about 1.5 g mild steel wool is adequate for treating nearly 100 liters of uranium bearing (500 ppb) aqueous solution.

The process results in the formation of ˜2 g U bearing ferrihydrite upon treatment of 100 liters of uranium bearing aqueous solution. The small sludge quantity ensures scalability of the process.

The uranium bearing ferrihydrite shows uranium loading of nearly 15,000-20,000 ppm on a w/w basis. Therefore, uranium recovery from this material is made viable.

1. A method for uranium removal from uranium bearing aqueous solution by freshly prepared fine ferrihydrite generated during ultrasonic assisted corrosion of mild steel wool wherein the uranium bearing aqueous solution is taken in a process tank (101) and the mild steel wool is taken in a generation tank (102), which is placed in an ultrasonic bath (103), characterized by the following steps:
(a) generating two-line ferrihydrite by corrosion of mild steel wool in the ultrasonic bath (103) by ultrasonic agitation;
(b) transferring the two-line ferrihydrite using a pump (104) from the generation tank to the process tank (101);
(c) mixing of the two-line ferrihydrite in the process tank (101) with the uranium bearing aqueous solution using air bubbling/air purging;
(d) circulating the solution from the process tank (101) to the generation tank (102) using an overflow line;
(e) repeating the steps (a) to (d) for 3 to 4 hours;
(f) removing the solution of step (d) to another container;
(g) settling of fine ferrihydrite corrosion product from the solution using alum applied as flocculent.

2. The process as claimed in claim 1, wherein the uranium bearing aqueous solution has a pH range of 6-8.

3. The process as claimed in claim 1, wherein the ultrasonic bath (103) is operated at a power of 1-2 kW and a frequency of 20 kHz.

4. The process as claimed in claim 1, wherein the uranium bearing aqueous solution is 100 liters tap water spiked with 500 ppb uranium (uranyl nitrate salt).

5. The process as claimed in claim 1, wherein 5 g mild steel wool was taken in the generation tank (102).

6. The process as claimed in step (g) of claim 1, wherein the typical settling time is 3 hours.
